(19) United States
(12) Patent Application Publication
(10) Pub. No.: US 2010/0029379 A1
(43) Pub. Date: Feb. 4, 2010

(54) System and method of playing online or webpage games via instant messaging software

(75) Inventor: Tien-Kuo Lo, Wugu Township (TW)

Correspondence Address: BACON & THOMAS, PLLC, 625 SLATERS LANE, FOURTH FLOOR, ALEXANDRIA, VA, 22314-1176, US

(73) Assignee: INTERNATIONAL GAMES SYSTEM CO., LTD., Wugu Township (TW)

(21) Appl. No.: 12/232,277

(22) Filed: Sep. 15, 2008

(30) Foreign Application Priority Data
Jul. 31, 2008 (TW) 097128956

(51) Int. Cl. G06F 17/00

(52) U.S. Cl. 463/29; 463/42

(57) ABSTRACT

A system of playing online or webpage games via instant messaging software includes at least one user terminal, at least one communication terminal and a game server. The user terminal installs instant communication software for logging on the instant communication server by a user terminal account ID and a user terminal password. The communication terminal logs on the instant communication server by a communication terminal account ID and a communication terminal password. The communication terminal establishes an online connection with the user terminal through the instant communication server to obtain the user terminal account ID and receive a game instruction from the user terminal. The game server includes a microprocessor and a game database for storing game information. If the communication terminal receives the game instruction, the communication terminal transmits the game instruction and the user terminal account ID to the microprocessor for the microprocessor to execute the game instruction.

### FIELD OF THE INVENTION

The present invention relates to a system and a method of playing online games or webpage games, and more particularly to a system and a method of playing online or webpage games via instant messaging software.

### BACKGROUND OF THE INVENTION

In the Seventies, Europe has developed a text-based online game: Multi-User Dungeon, Multiple User Dialogue or Multi-User Dimension (MUD), and Chinese players generally call this game “Internet Mud” or “Mud”. MUD is built on the Internet as shown in FIG, 1 and comprises a game server 11 and a plurality of user terminals 12 (such as personal computers or notebook computers), and the user terminals 12 install MUD specified client software such as Zugg's MUD Client (zMUD), and the user terminals 12 are connected to the game server 11 through the client software for playing an online game. Players enter a game instruction composed of a text into the game server 11 through the client software to control a game character, such that the game character can start an adventure in a scene created by the game server 11, and interact with a non-player character (NPC) controlled by the game server 11, or a game character controlled by other players, and these interactions include talking, trading or fighting. However, the online game MUD with a textual interface is replaced gradually by a graphical massively multiplayer online character-playing game as the display performance and the computing speed of personal computers are enhanced. Obviously, online games with a textual interface will be replaced by the graphic online game eventually, as the network transmission rate is improved greatly.

With reference to FIG. 1 for a main structure of the graphic online game, the structure includes a game server 11 and a plurality of user terminals 12, and the game server 11 installs a game program, and players have to install a client software corresponding to the game program in the user terminals 12 before the user terminals 12 can log on the game server 11 for playing online games, wherein the client software is provided by a game provider. In a graphic online game, players generally use a mouse and a keyboard to send a game instruction to the game server 11 for controlling a game character or playing the game provided by the game server 11. Compared with the MUD (having a textual interface), the graphic online game gives better audio and video effects, and thus the graphic online game has gradually replaced MUD and become a mainstream of online games.

Although the graphic online game can provide better audio and video effects and fun, players have to download or purchase the client software provided by the game provider and install the client software in the user terminals 12 before they can play the graphic online games, and such arrangement is very inconvenient. Furthermore, the file size of the client software is usually several gigabytes (GB), and thus the client software installed in the user terminal 12 occupies a large memory space in a hard disk, even if the players purchase the client software in order to save the long download time of the client software, and the client software must be run in a high-performance personal computer for a smooth execution of the software. In other words, the client software not only requires a high-end personal computer, but also uses los of computer system resources (such as a large memory space), and thus these online games require improvements.

If the environment of a player is not suitable for executing the client software (such as in an office), or a player cannot install the client software in the user terminal 12 (such as a public computer with a limited access), the player is inconvenient or unable to execute the client software to play the online game. If the player wants to play webpage games, the player has open a webpage browser to play the games successfully, but the player may have access limitations in office for playing webpage games.

Therefore, it is an important subject of the present invention to improve the online game and the webpage game, such that players need not install specific client software to control a game character in a game server for playing an online game, and players need not execute a webpage browser to play a webpage game. In other words, players can play online games freely anytime and anywhere without being limited by the environment.

### SUMMARY OF THE INVENTION

In view of the shortcomings of the prior art, the inventor of the present invention based on years of experience in the related industry to conduct extensive researches and experiments, and finally invented a system and method of playing online or webpage games via instant messaging software, so that users can play games via an instant communication software without being limited by the environment.

It is a primary objective of the present invention to provide a system of playing online or webpage games via instant messaging software, and the system comprises at least one user terminal, at least one communication terminal and a game server, wherein the user terminal installs an instant communication software (such as MSN, ICQ and SKYPE), such that the user terminal with a user terminal account ID and a user terminal password can pass the verification of an instant communication server (such as Microsoft MSN server) and log on the instant communication server, and the communication terminal with a communication terminal account ID and a communication terminal password can pass the verification of the instant communication server and log on the instant communication server. The communication terminal establishes an online connection with the user terminal through the instant communication server to obtain the user terminal account ID and receive a game instruction transmitted from the user terminal. The game server comprises a game database and a microprocessor, wherein the game database is connected with the microprocessor, and the game database stores a plurality of game information, and each game information comprises an account ID information, a character name and a group of character's power values (such as military force, food and money, etc), and each account ID information corresponds to each user terminal account ID. When the communication terminal has received the game instruction, the communication terminal transmits the game instruction and the user terminal account ID to the microprocessor, and the microprocessor reads the game information corresponding to the user terminal account ID from the game database, and performs a computation according to the game instruction to update the game information, and transmits the updated game information to the user terminal through the communication terminal. Therefore, players need not install additional online game software into the user terminal, but simply log on the instant communication server from the user terminal to establish an online connection with the communication terminal and transmit a game instruction to the game server, so as to enhance the convenience of playing online games.

Another objective of the present invention is to provide a system of playing online or webpage games via instant messaging software, wherein the game instruction is comprised of a motion string and a target string, and after the communication terminal has received the game instruction, the communication terminal transmits the game instruction and the user terminal account ID to the microprocessor, and the microprocessor reads game information corresponding to the user terminal account ID from the game database, and reads game information corresponding to a target string, and performs a computation according to the game instruction while updating the game information, and the microprocessor transmits the updated game information to each user terminal through the communication terminal according to the account ID information in the game information.

A further objective of the present invention is to provide a system of playing online or webpage games via instant messaging software, wherein the communication terminal includes an instruction list that stores a plurality of compare instructions, so that when the communication terminal receives the game instruction and the game instruction matches the compare instruction in the instruction list, the communication terminal transmits the game instruction and the user terminal account ID to the microprocessor to reduce the burden of the game server effectively.

Another objective of the present invention is to provide a method of playing online or webpage games via instant messaging software, and the method comprises the following steps:

A user terminal passes the verification of an instant communication server, and logs on the instant communication server.

A communication terminal passes the verification of the instant communication server and logs on the instant communication server.

The communication terminal receives the game instruction and the user terminal account ID transmitted from the user terminal through the instant communication server.

The communication terminal transmits the game instruction and the user terminal account ID of the user terminal to a game server.

The game server reads the game information corresponding to the user terminal account ID, and performs a computation according to the game instruction to update the game information.

Finally, the game server transmits the updated game information to the user terminal through the communication terminal.

With this method, players simply operates the user terminal, such that the user terminal passes the verification of the instant communication server to connect the user terminal with the communication terminal for playing an online game, and players no longer need to install additional software for playing online games through the instant communication software anywhere and anytime. In addition, the instant communication software is a free popular software tool with a small file size and an easy access, and it attracts the attention of instant communication software users to become online game players. In addition, the operation of the instant communication software is simple and easy, and thus it facilitates game providers to promote and expand the online game population.

### BRIEF DESCRIPTION OF THE DRAWINGS

FIG. 1 is a system block diagram of a conventional online game;

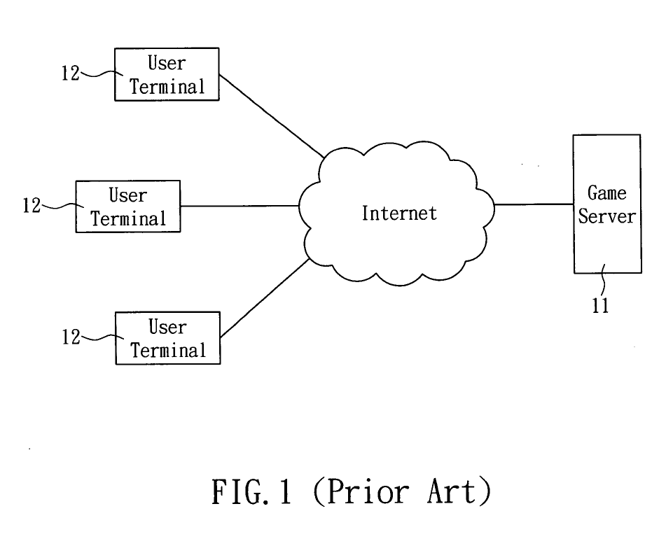

FIG. 2 is a block diagram of a first preferred embodiment of the invention;

FIG. 3 is a flow chart of logon and registration in accordance with a first preferred embodiment of the invention;

FIG. 4 is a flow chart of a first preferred embodiment of the invention;

FIG. 5 is a flow chart of a second preferred embodiment of the invention;

FIG. 6 is a flow chart of a third preferred embodiment of the invention;

FIG. 7 is shows a dialog window of an instant communication software of a user terminal in accordance with the present invention; and

FIG. 8 is a flow chart of a third preferred embodiment of the invention.

### DETAILED DESCRIPTION OF THE PREFERRED EMBODIMENTS

To make it easier for our examiner to understand the technical characteristics of the present invention, we use preferred embodiments together with the accompanying drawings for the detailed description of the invention as follows:

Two players A, B separately own a user terminal (such as a personal computer or a notebook computer, etc), and each user terminal installs an instant communication software (such as MSN, ICQ and SKYPE, etc), and Player A owns a user terminal account ID: “X@igs.com.tw”, and the user terminal of Player A can log on an instant communication server (such as Microsoft MSN server) by the user terminal account ID (X@igs.com.tw), and Player B owns another user terminal account ID: “Y@igs.com.tw”, and the user terminal of Player B can log on the instant communication server by another user terminal account ID (Y@igs.com.tw). If Player A wants to transmit a message to Player B, Player A has to enter Player B's user terminal account ID “Y@igs.com.tw” in the instant communication software to set Player B as a friend. If Player B agrees to accept the invitation of being a “Friend”, Player B will be able to obtain Player A's user terminal account ID, and then Players A and B can send messages to each other through the instant communication server.

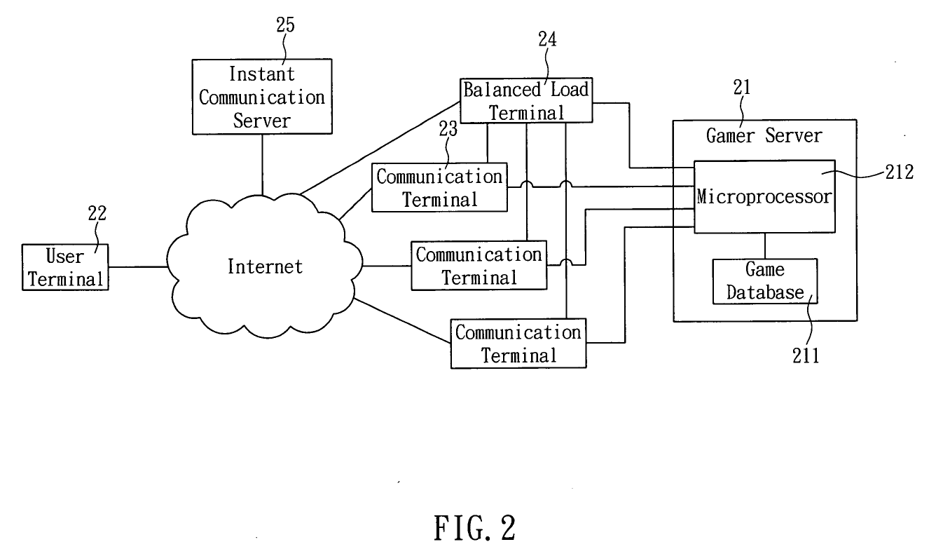

With reference to FIG. 2 for a system of playing online or webpage games via instant messaging software in accordance with a preferred embodiment of the present invention, the system comprises a user terminal 22, a plurality of communication terminals (wherein one of the communication terminals is labeled as 23 in the FIG. 2), a balanced load terminal 24 and a game server 21, wherein the user terminal 22 is a personal computer, a notebook computer or another electronic communication device such as a mobile phone, a personal digital assistant (PDA), and the user terminal 22 installs an instant communication software, such that a user terminal account ID and a user terminal password can be used for the player's user terminal 22 to pass the verification of an instant communication server 25 and log on the instant communication server 25. The communication terminals, the balanced load terminal 24 and the game server 21 are provided by game providers. In this embodiment, the communication terminals are connected separately to the balanced load terminal 24, and the communication terminals and the balanced load terminal 24 are personal computers or servers, but not limited to such arrangement only, and the game providers can integrate the communication terminals and the balanced load terminal 24 into a server or a personal computer according to actual needs (or factors such as network flow, number of players and level of complexity of the game), or the communication terminals and the balanced load terminal 24 are integrated into the game server 21. In the present invention, game providers install a program (not limited to the instant communication software only) capable of communicating with the instant communication server 25 in the balanced load terminal 24 and the communication terminals, so that the communication terminals and the balanced load terminal 24 can perform the following operations.

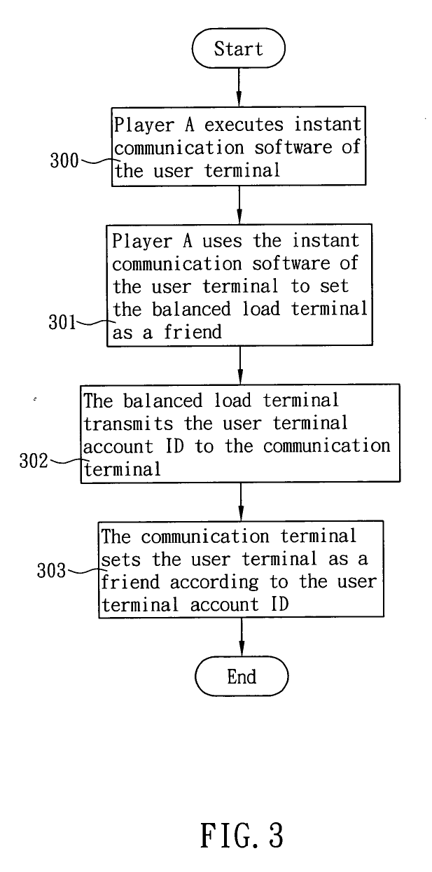

The communication terminal 23 passes the verification of the instant communication server 25 by means of a communication terminal account ID and a communication terminal password to connect the instant communication server 25, and the balanced load terminal 24 owns a logon account ID and a logon password, and the balanced load terminal 24 can be connected to the instant communication server 25 by means of the logon account ID and the logon password. In FIGS. 2 and 3, if Player A wants to join an online game provided by the game server 21, Player A can log on and register to obtain the right of playing the online game as follows:
(300) Player A executes instant communication software of the user terminal 22.
(301) Player A uses the instant communication software of the user terminal 22 to set the balanced load terminal 24 with the logon account ID as a friend, and now the balanced load terminal 24 will receive Player A's user terminal account ID.
(302) The balanced load terminal 24 transmits the user terminal account ID to the communication terminal 23.
(303) The communication terminal 23 sets the user terminal 22 with the user terminal account ID as a friend according to the user terminal account ID.

Therefore, the user terminal 22 can establish an online connection with the communication terminal 23 by the instant communication server 25, and the communication terminal 23 obtains the user terminal account ID. In other words, Player A can transmit messages to the communication terminal 23 from the user terminal 22, and the user terminal 22 can receive messages from the communication terminal 23. It is noteworthy to point out that the aforementioned procedure is simply a logon and registration method, and the technical characteristic of the present invention is not limited to such procedure only, but the logon and registration procedure can be changed. For example, a player can directly use the user terminal 22 to set the communication terminal 23 as a friend, so that the communication terminal 23 obtains the user terminal account ID to allow the user terminal 22 to establish an online connection with the communication terminal 23 directly without going through the balanced load terminal 24.

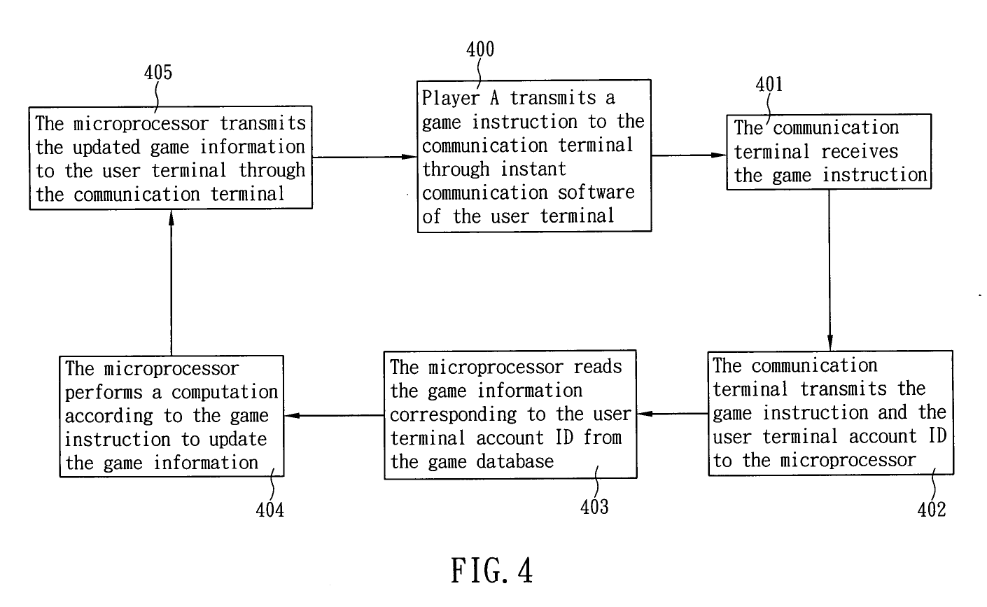

In FIG. 2, the game server 21 comprises a game database 211 and a microprocessor 212, wherein the microprocessor 212 is connected separately to the communication terminal, and the game database 211 is connected to the microprocessor 212, and the game database 211 stores a plurality of game information, and each game information comprises an account ID information, a character name and a group of character's power values. In this embodiment, both of the Player A's user terminal account ID and account ID information are ^{┌} igs@igs.com.tw _{┘}, and Player A's character name is “Liu Bei”, and Player A's character power values are: “Military Force: 5000, Food: 1000 and Money: 500”. With reference to FIG. 4, Player A can play an online game as follows:
(400) Player A transmits a game instruction (such as drafting soldiers) to the communication terminal 23 through instant communication software of the user terminal.
(401) The communication terminal 23 receives the game instruction.
(402) The communication terminal 23 transmits the game instruction (drafting soldiers) and the user terminal account ID (igs@igs.com.tw) to the microprocessor 212.
(403) The microprocessor 212 reads the game information corresponding to the user terminal account ID from the game database 211.
(404) The microprocessor 212 performs a computation according to the game instruction to update the game information, such that after the game information is updated, Player A's power values become: “Military Force: 5500, Food: 800 and Money: 200”.
(405) The microprocessor 212 transmits the updated game information to the user terminal 22 through the communication terminal 23.

Therefore, players can know about the result produced by the game instruction through the user terminal 22. With the foregoing procedure, a player can control the role (or the character “Liu Bei” in this embodiment) that he/she plays in order to play the online game provided by the game server 21. The players need not install additional client software in the user terminal 22, but simply uses instant communication software of the user terminal 22 to transmit the game instruction to the game server 21 through the communication terminal 23, so as to greatly enhance the convenience of playing online games. Since the instant communication software is a popular free software tool, therefore players not only can play online games freely anywhere and anytime, but also can make use of the group function of the instant communication software to ask their friends to join the game, so as to improve the variety and fun of the game.

In the foregoing preferred embodiment of the present invention, the balanced load terminal 24 can be designed in a way that it is connected to the game server 21, so that when a user's user terminal account ID is obtained from the balanced load terminal 24, the balanced load terminal 24 compares the user terminal account ID with the game information in the game database 211. Such arrangement not only prevents a same player from logging on and making a registration twice, but also reduces the burden of the game server 21 effectively.

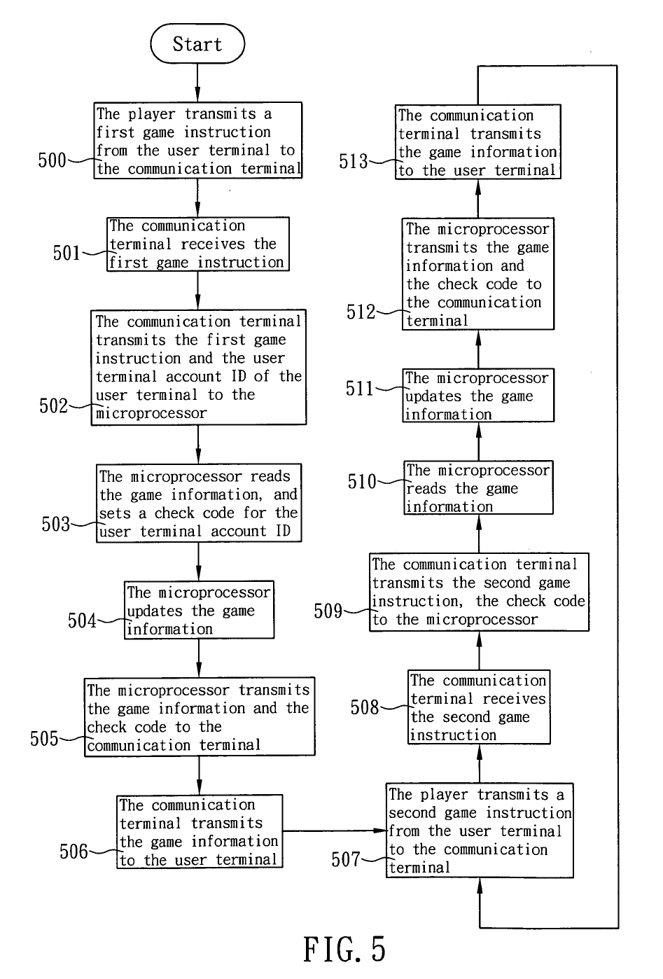

In a second preferred embodiment of the invention, a system of playing online or webpage games via instant messaging software is the same as that disclosed in the first preferred embodiment (as shown in FIG. 2), the players follow the procedure below and as shown in FIG. 5 for playing an online game:
(500) The player transmits a first game instruction from the user terminal 22 to the communication terminal 23.
(501) The communication terminal 23 receives the first game instruction.
(502) The communication terminal 23 transmits the first game instruction and the user terminal account ID of the user terminal 22 to the microprocessor 212.
(503) The microprocessor 212 reads the game information corresponding to the user terminal account ID from the game database 211, and sets a check code for the user terminal account ID.
(504) The microprocessor 212 performs a computation according to the first game instruction and updates the game information.
(505) The microprocessor 212 transmits the game information and the check code to the communication terminal 23.
(506) The communication terminal 23 transmits the game information to the user terminal 22.
(507) The player transmits a second game instruction from the user terminal 22 to the communication terminal 23.
(508) The communication terminal 23 receives the second game instruction.
(509) The communication terminal 23 transmits the second game instruction and the check code corresponding to the user terminal account ID to the microprocessor 212.
(510) The microprocessor 212 reads the game information corresponding to the check code from the game database 211.
(511) The microprocessor 212 performs a computation according to the second game instruction and updates the game information.
(512) The microprocessor 212 transmits the game information and the check code to the communication terminal 23.
(513) The communication terminal 23 transmits the game information to the user terminal 22 according to the user terminal account ID of the check code, and the procedure returns to Step (507).

For the first time when a player transmits a game instruction to the game server 21 through the user terminal 22, the game server 21 sets a check code for the user terminal account ID to facilitate later steps of the procedure, and the communication terminal 23 simply needs to transmit the check code to the game server 21, so that the game server 21 reads and updates the corresponding game information.

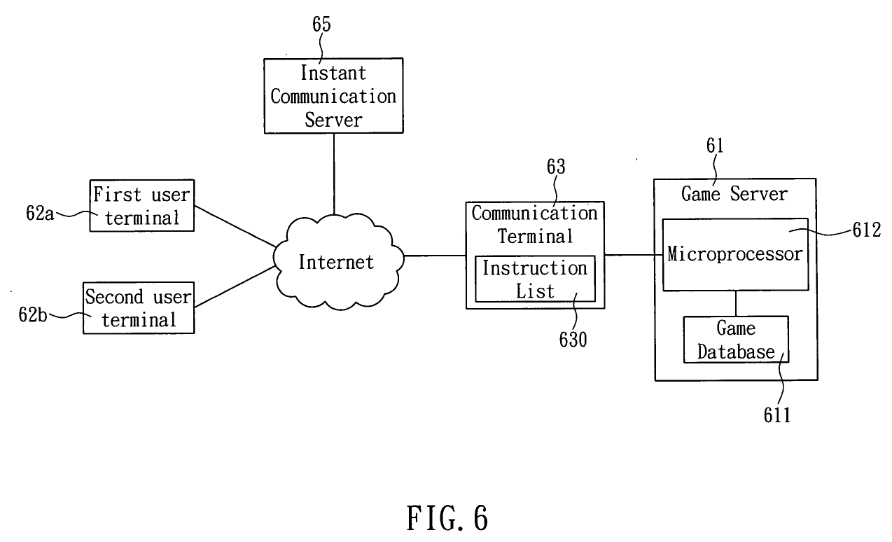

With reference to FIG. 6 for a system of playing online or webpage games via instant messaging software in accordance with a third preferred embodiment of the present invention, the system comprises two user terminals 62a, 62b, a communication terminal 63 and a game server 61, wherein each user terminal 62a, 62b installs instant communication software, and the first user terminal 62a is controlled by Player A, and the second user terminal 62b is controlled by Player B, and the user terminal account ID of Player A (the first user terminal 62a) is “igs@igs.com.tw”, and the user terminal account ID of Player B (the second user terminal 62b) is “igs2@igs.com.tw”. Both user terminals 62a, 62b pass the verification of an instant communication server 65 and log on the instant communication server 65, and the communication terminal 63 establishes an online connection with the user terminals 62a, 62b through the instant communication server 65. The game server 61 comprises a game database 611 and a microprocessor 612, wherein the game database 611 is connected to the microprocessor 612, and the game database 611 stores a plurality of game information, and each game information comprises an account ID information, a character name and a group of character's power values, wherein the account ID information of Player A is “igs@igs.com.tw” and the character name of Player A is “Liu Bei”, and the character's power values of Player A are “Military Force: 5000, Food: 1000, and Money: 500”. The account ID information of Player B is “igs2@igs.com.tw”, and the character name of Player B is “Tsao Tsao” and the character's power values of Player B are “Military Force: 10000, Food: 5000 and Money: 1500”.

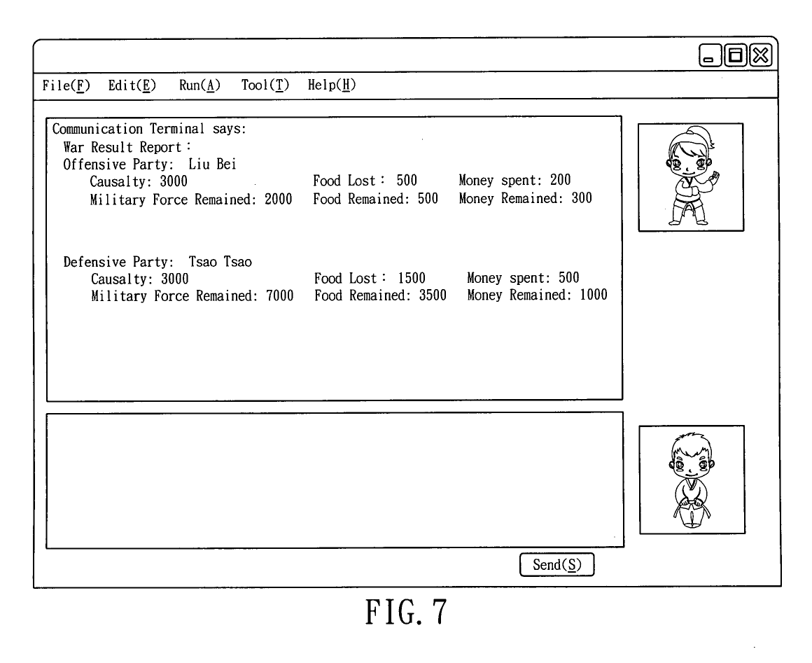

Player A transmits a game instruction “Attack Tsao Tsao” to the communication terminal 63 through the first user terminal 62a, wherein the game instruction is comprised of a motion string “Attack” and a target string “Tsao Tsao”. After the communication terminal 63 receives the game instruction, the communication terminal 63 sends the game instruction (Attack Tsao Tsao) and the user terminal account ID (igs@igs.com.tw) of Player A to the microprocessor 612, and then the microprocessor 612 reads a game information (which is the game information of Player A) corresponding to the user terminal account ID of Player A from the game database 611, and reads a game information (which is the game information of Player B) corresponding to the target string according to the target string, and performs a computation according to the game instruction, and updates the game information of both players A, B. After the game information are updated, the character's power values of Player A become “Military Force: 2000, Food: 500 and Money: 300”, and the character's power values of Player B become “Military Force: 7000, Food: 3500 and Money: 1000”. In a dialog window of the instant communication software as shown in FIG. 7, the microprocessor 612 updates the game information according to the account ID information through the communication terminal 63, and transmits the updated game information to each user terminal 62a, 62b, so that Players A and B can know the result produced after the war between Players A and B through each user terminal 62a, 62b.

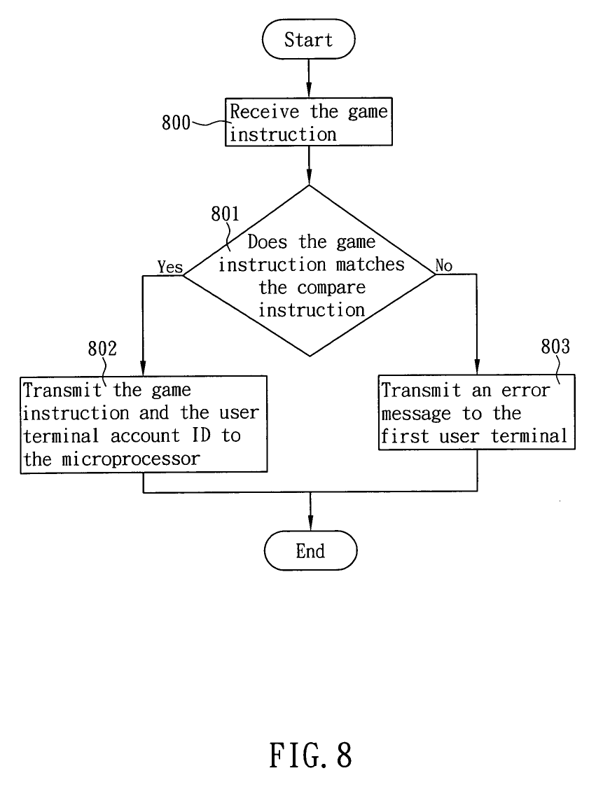

In the third preferred embodiment of the invention as shown in FIG. 6, the communication terminal 63 further comprises an instruction list 630 that stores a plurality of compare instructions, and the communication terminal 63 performs the following procedure as shown in FIG. 8. The first user terminal 62a transmits the game instruction and the user terminal account ID of the first user terminal 62a to the microprocessor 612, or transmits an error message to the first user terminal 62a.
(800) Receive the game instruction from the first user terminal 62a.
(801) Read a compare instruction in the instruction list 630, and determine whether or not the game instruction matches the compare instruction in the instruction list 630; if yes, then go to Step (802), or else go to Step (803).
(802) Transmit the game instruction and the user terminal account ID to the microprocessor 612.
(803) Transmit the error message (such as “Error Message! Enter again.” through the instant communication server 65 to the first user terminal 62a.

If the communication terminal 63 determines that the game instruction matches the compare instruction in the instruction list 630, the game instruction and the user terminal account ID can be transmitted to the microprocessor 612. In other words, the game server 61 just receives a correct game instruction, and performs a computation according to the game instruction. Such arrangement not only reduces the burden of the game server 61 effectively, but also allows users to receive an error message after a wrong game instruction is entered, so as to reenter a correct game instruction.

In summation of the description above, the present invention can achieve the following functions and effects:
1. Players need not install specific client software to control a game character in the game server for playing an online game.
2. The instant communication software is a free software tool with a small file size, an easy access and a high popularity, and thus it attracts instant communication software users to become online game players.
3. Players need not inform other players about the user terminal account ID to play online games with other players through the communication terminal and the game server.
4. With the group function of the instant communication software, players can ask their friends to join the game easily, so as to give more varieties and fun to the game.
5. The format of the game instruction is simple, and thus players can play the game easily.

While the invention has been described by means of specific embodiments, numerous modifications and variations could be made thereto by those skilled in the art without departing from the scope and spirit of the invention set forth in the claims.

What is claimed is:

1. A system of playing online or webpage games via instant messaging software, comprising:
at least one user terminal, each having an instant communication software installed therein, and using a user terminal account ID and a user terminal password to pass the verification of an instant communication server and log on the instant communication server to issue a game instruction;
at least one communication terminal, each using a communication terminal account ID and a communication terminal password to pass the verification of the instant communication server and log on the instant communication server, and creating an online connection with the user terminal through the instant communication server for receiving the game instruction and the user terminal account ID, and sending out the game instruction and the user terminal account ID; and
a game server, including a microprocessor and a game database, and the microprocessor being coupled separately to the communication terminal and the game database, and the game database storing a plurality of game information, and the microprocessor receiving the game instruction and the user terminal account ID transmitted from the communication terminal, and reading the game information corresponding to the user terminal account ID from the game database, and performing a computation according to the game instruction to update the game information, and transmitting the updated game information to the user terminal through the communication terminal.

2. The system of playing online or webpage games via instant messaging software of claim 1, wherein each game information comprises an account ID information, a character name and a group of character's power values, and each account ID information corresponds to a user terminal account ID of each user terminal.

3. The system of playing online or webpage games via instant messaging software of claim 2, wherein the game instruction is comprised of a motion string and a target string.

4. The system of playing online or webpage games via instant messaging software of claim 3, wherein the game information corresponding to the target string is read and updated according to the game instruction when the microprocessor receives the target string.

5. A system of playing online or webpage games via instant messaging software, comprising:
at least one user terminal, each having an instant communication software installed therein, and the user terminal using a user terminal account ID and a user terminal password to pass the verification of an instant communication server and log on the instant communication server to issue a game instruction;
at least one communication terminal, each having an instruction list for storing a plurality of compare instructions, and the communication terminal using a communication terminal account ID and a communication terminal password to pass the verification of the instant communication server and log on the instant communication server, and creating an online connection with the user terminal through the instant communication server for receiving the game instruction and the user terminal account ID, and sending out the game instruction and the user terminal account ID when the game instruction matches the compare instruction in the instruction list; and
a game server, including a microprocessor and a game database, and the microprocessor being coupled separately to the communication terminal and the game database, and the game database storing a plurality of game information, and the microprocessor receiving the game instruction and the user terminal account ID transmitted from the communication terminal, and reading the game information corresponding to the user terminal account ID from the game database, and performing a computation according to the game instruction to update the game information, and transmitting the updated game information to the user terminal through the communication terminal.

6. The system of playing online or webpage games via instant messaging software of claim 5, wherein each game information comprises an account ID information, a character name and a group of character's power values, and each account ID information corresponds to a user terminal account ID of each user terminal.

7. The system of playing online or webpage games via instant messaging software of claim 6, wherein the game instruction is comprised of a motion string and a target string.

8. The system of playing online or webpage games via instant messaging software of claim 7, wherein the game information corresponding to the target string is read and updated according to the game instruction when the microprocessor receives the target string.

9. A method of playing online or webpage games via instant messaging software, comprising:
a user terminal passing the verification of an instant communication server and logging on the instant communication server;
a communication terminal passing the verification of the instant communication server, and logging on the instant communication server;
the communication terminal receiving the game instruction and the user terminal account ID transmitted from the user terminal through the instant communication server;
the communication terminal transmitting the game instruction and the user terminal account ID to a game server;
the game server reading a game information corresponding to the user terminal account ID, an performing a computation according to the game instruction to update the game information; and
the game server transmitting the updated game information to the user terminal through the communication terminal.

10. The method of playing online or webpage games via instant messaging software of claim 9, wherein each game information comprises an account ID information, a character name and a group of character's power values, and each account ID information corresponds to a user terminal account ID of each user terminal.

11. The method of playing online or webpage games via instant messaging software of claim 10, wherein the game instruction is comprised of a motion string and a target string.

12. The method of playing online or webpage games via instant messaging software of claim 11, further comprising: the game server reading and updating the game information corresponding to the target string according to the game instruction.

13. A method of playing online or webpage games via instant messaging software, comprising:
a user terminal passing the verification of an instant communication server, and logging on the instant communication server;
a communication terminal passing the verification of the instant communication server, and logging on the instant communication server; the communication terminal receiving the game instruction and the user terminal account ID transmitted from the user terminal through the instant communication server;
the communication terminal transmitting the game instruction and the user terminal account ID to a game server, when the game instruction is determined to match a compare instruction in the communication terminal;
the game server reading the game information corresponding to the user terminal account ID, and performing a computation according to the game instruction to update the game information; and
the game server transmitting the updated game information to the user terminal through the communication terminal.

14. The method of playing online or webpage games via instant messaging software of claim 13, wherein each game information comprises an account ID information, a character name and a group of character's power values, and each account ID information corresponds to a user terminal account ID of each user terminal.

15. The method of playing online or webpage games via instant messaging software of claim 14, wherein the game instruction is composed of a motion string and a target string.

16. The method of playing online or webpage games via instant messaging software of claim 15, further comprising:
the game server reading and updating the game information corresponding to the target string according to the game instruction.
